(19) United States
(12) Patent Application Publication
(10) Pub. No.: US 2022/0018045 A1
(43) Pub. Date: Jan. 20, 2022

(54) ELECTROSPUN COAXIAL POLYMER FIBERS FOR CONTROLLED INSECT REPELLENT RELEASE

(71) Applicant: The Government of the United States of America, as represented by the Secretary of the Navy, Arlington, VA (US)

(72) Inventors: Jeffrey G. Lundin, Burke, VA (US); Justin Ryan, III, Chapel Hill, NC (US); Riccardo Casalini, Hyattsville, MD (US); Joshua Alan Orlicki, Havre de Grace, MD (US)

(73) Assignees: The Government of the United States of America, as represented by the Secretary of the Navy, Arlington, VA (US); The United States of America, as represented by the Secretary of the Army, Washington, DC (US)

(21) Appl. No.: 17/377,795

(22) Filed: Jul. 16, 2021

Related U.S. Application Data
(60) Provisional application No. 63/052,663, filed on Jul. 16, 2020.

(51) Int. Cl. D02G 3/36; A01N 43/40; A01N 25/34

(52) U.S. Cl. CPC D02G 3/36; D10B 2331/021; A01N 25/34; A01N 43/40

(57) ABSTRACT

Disclosed herein are fibers having a polymer, such as a textile polymer, and an insect repellant, such as picaridin. The fiber may have a core of the polymer and repellant surrounded by a sheath of the polymer. The fiber may be made by electrospinning a solution of the polymer and the repellant.

This application claims the benefit of U.S. Provisional Application No. 63/052,663, filed on Jul. 16, 2020. The provisional application and all other publications and patent documents referred to throughout this nonprovisional application are incorporated herein by reference.

### TECHNICAL FIELD

The present disclosure is generally related to textile fibers containing insect repellant.

### DESCRIPTION OF RELATED ART

Biting arthropods (e.g. mosquitos and ticks) not only present incessant irritation, but also function as significant vectors that spread disease among populations. Other than physical barriers such as mosquito netting, the most successful method to reduce insect bites has been the application of chemical-based repellents, often aerosol-type spray or topical lotion, that deter insects from a particular area or person (Katz et al., “Insect repellents: Historical perspectives and new developments” J. Am. Acad. Dermatology 2008, 58(5), 865-871). Currently, there are several repellents approved by the FDA, of which N,N-diethyl-meta-toluamide (DEET) is the most popular, followed by 1-(1-methylpropoxycarbonyl)-2-(2-hydroxyethyl)piperidine (picaridin), ethyl N-acetyl-N-butyl-β-alaninate (IR3535), and other essential oils (Tavares et al., “Trends in insect repellent formulations: A review” Int. J. Pharm. 2018, 539(1), 190-209). The repellent mechanism for each insect repellent differs. For example, DEET has been proposed to repel insects through multiple mechanisms, both through avoidance via olfactory binding and as an olfactory confusant by masking the host's odors (DeGennaro, “The mysterious multi-modal repellency of DEET” Fly 2015, 9(1), 45-51; Swale et al., “Neurotoxicity and Mode of Action of N, N-Diethyl-Meta-Toluamide (DEET)” PLOS ONE 2014, 9(8), e103713). Picaridin interacts with similar olfactory binding sites as DEET due to structural similarity, but also binds to other novel sites providing a slightly different mode of action (Drakou et al., “The crystal structure of the AgamOBP1⋅Icaridin complex reveals alternative binding modes and stereo-selective repellent recognition” Cell. Mol. Life Sci. 2017, 74(2), 319-338). In contrast, (3-phenoxyphenyl)methyl-3-(2,2-dichloroethenyl)-2,2-dimethylcyclopropane-1-carboxylate (Permethrin) is an effective insecticide that kills insects and ticks through neurotoxic means (Katz et al., “Insect repellents: Historical perspectives and new developments” J. Am. Acad. Dermatology 2008, 58(5), 865-871). Compared to DEET, picaridin exhibits comparable repellency against both mosquitos and ticks (Klun et al., “Repellent and Deterrent Effects of SS220, Picaridin, and Deet Suppress Human Blood Feeding by Aedes aegypti, Anopheles stephensi, and Phlebotomus papatasi” J. Med. Entomology 2006, 43(1), 34-39; Büchel et al. “Repellent efficacy of DEET, Icaridin, and EBAAP against Ixodes ricinus and Ixodes scapularis nymphs (Acari, Ixodidae)” Ticks and Tick-borne Diseases 2015, 6(4), 494-498), yet picaridin has lower toxicity, less skin irritation, better compatibility with plastics, and slightly longer duration (Diaz, “Chemical and Plant-Based Insect Repellents: Efficacy, Safety, and Toxicity” Wilderness & Environmental Medicine 2016, 27(1), 153-163).

An inherent limitation to insect repellents is their finite efficacy time due to evaporation of the liquid-based repellents. A common strategy to combat this limitation has been to control the repellent release rate and/or to provide a reservoir from which to draw additional repellent. Polyester fabrics were modified to exhibit repellency by modification with complexed DEET with a cyclodextrin and grafting through an anhydride that demonstrated improved resiliency to washing with detergents (Peila et al., “Synthesis and characterization of β-cyclodextrin nanosponges for N,N-diethyl-meta-toluamide complexation and their application on polyester fabrics” React. Funct. Polym. 2017, 119, 87-94). A common approach is to mix the insect repellent directly into a polymer solution prior to production into a fiber or coating. For example, DEET was incorporated into polylactic acid fibers via coextrusion for potential textile applications, where DEET reduced mechanical properties of the PLA fibers while only contributing minor repellent effects (Annandarajah et al., “Biobased plastics with insect-repellent functionality” Polym. Engin. & Sci. 2019, 59(s2), E460-E467). Modified polymer coatings are also employed to impart insect repellents to existing materials. Recently, applications of DEET and IR3535 polymer-based coatings to netting were demonstrated to provide a physical barrier that also exhibited repellent properties that lasted up to 29 weeks (Faulde et al., “Insecticidal, acaricidal and repellent effects of DEET- and IR3535-impregnated bed nets using a novel long-lasting polymer-coating technique” Parasitology Res. 2010, 106(4), 957-965). Another approach is the incorporation of particles, or capsules, that contain insect repellent, which are then imparted onto a material to provide long-term repellency with improved water resistance. For example, microcapsules composed of picaridin encapsulated with commercial antibacterial and antifungal microbiocide polymer demonstrated significant stability in water and maintained efficacious levels of insect repellency when adsorbed onto nylon-cotton blended fabric (Place et al., “Preparation and characterization of PHMB-based multifunctional microcapsules” Colloids and Surfaces A: Physicochemical and Engineering Aspects 2017, 530 (Supplement C), 76-84). Nanospheres containing DEET fabricated from miniemulsion polymerization resulted in sustained and temperature dependent release kinetics (Gomes et al., “Encapsulation of N,N-diethyl-meta-toluamide (DEET) via miniemulsion polymerization for temperature controlled release” J. Appl. Polym. Sci. 2019, 136(9), 47139). Furthermore, covalent attachment of DEET to nylon 6 via dye modification demonstrated some insect repellent activity, though chemical modification of DEET reduced efficacy in some cases (Akbarzadeh et al., “Imparting insect repellency to nylon 6 fibers by means of a novel MCT reactive dye” J. Appl. Polym. Sci. 2012, 126(3), 1097-1104).

Electrospinning is a facile method for the fabrication of micro- and nano-scale polymer fibers (Luo et al., “Electrospinning versus fibre production methods: from specifics to technological convergence” 10.1039/C2CS35083A. Chem. Soc. Rev. 2012, 41(13), 4708-4735). Recently, electrospinning has shown broad capability to generate a variety of polymer fibers of single and composite composition (Lundin et al., “Relationship between surface concentration of amphiphilic quaternary ammonium biocides in electrospun polymer fibers and biocidal activity” React. Funct. Polym. 2014, 77, 39-46; Bischel et al., “Electrospun gelatin biopapers as substrate for in vitro bilayer models of blood-brain barrier tissue” J. Biomed. Mat. Res. A. 2016, 104(4), 901-909; Bertocchi et al., “Electrospinning of Tough and Elastic Liquid Crystalline Polymer-Polyurethane Composite Fibers: Mechanical Properties and Fiber Alignment” Macromol. Mat. and Engin. 2019, 304(8), 1900186). Electrospun polylactic acid fibers containing DEET at concentrations exceeding 50 wt % demonstrated uniform fiber morphology and delayed evaporation of DEET as compared to the neat repellent (Bonadies et al., “Electrospun fibers of poly(l-lactic acid) containing DEET” AIP Conf Proc. 2018, 1981(1), 020112; Bonadies et al., “Biodegradable electrospun PLLA fibers containing the mosquito-repellent DEET” Eur. Polym. J. 2019, 113, 377-384). Furthermore, electrospun pyromellitic dianhydride-cyclodextrin-based fibers were loaded with DEET and shown to maintain fiber morphology, as well as provide increased release times (Cecone et al., “Controlled Release of DEET Loaded on Fibrous Mats from Electrospun PMDA/Cyclodextrin Polymer” Molecules 2018, 23(7), 1694). Interestingly, coaxial electrospinning provides yet another layer of control (Yarin, “Coaxial electrospinning and emulsion electrospinning of core-shell fibers” Polym. Adv. Technol. 2011, 22(3), 310-317), where fibers with core-sheath morphology are fabricated to contain different composition in the center of a polymer micro-/nano-fiber, including liquids (Bertocchi et al., “Electrospun Polymer Fibers Containing a Liquid Crystal Core: Insights into Semi-Flexible Confinement” J. Phys. Chem. C 2018, 122, 29, 16964-16973; Bertocchi et al., “Enhanced Mechanical Damping in Electrospun Polymer Fibers with Liquid Cores: Applications to Sound Damping” ACS App. Polym. Mat. 2019, 1(8), 2068-2076; Dicker et al., “Surfactant Modulated Phase Transitions of Liquid Crystals Confined in Electrospun Coaxial Fibers” Langmuir 2020, 36, 27, 7916-7924) and bioactive compounds (Ghorani et al., “Fundamentals of electrospinning as a novel delivery vehicle for bioactive compounds in food nanotechnology” Food Hydrocolloids 2015, 51, 227-240). Coaxial electrospinning is a convenient and inexpensive method to control morphology and composition, the designs of which can be applied to large-scale fabrication techniques, such as melt extrusion or spinning, for scale-up. Recently, melt spinning was used to fabricate bicomponent fibers composed of a DEET and poly(ethylene-co-vinyl acetate) core surrounding by a HDPE sheath that demonstrated long-term efficacy following numerous cold water washes (Sibanda et al. “Bicomponent fibres for controlled release of volatile mosquito repellents” Mat. Sci. and Engin.: C. 2018, 91, 754-761.). Such fibers have not yet been demonstrated using picaridin with traditional textile relevant polymers.

### BRIEF SUMMARY

Disclosed herein is a fiber comprising: a polymer and picaridin.

Also disclosed herein is a fiber comprising: a textile polymer and an insect repellant.

Also disclosed herein is a fiber comprising: a core and a sheath. The core comprises a polymer and an insect repellant. The sheath comprises the polymer.

Also disclosed herein is a method comprising: electrospinning a solution comprising a first polymer and an insect repellant to form a fiber.

### BRIEF DESCRIPTION OF THE DRAWINGS

A more complete appreciation will be readily obtained by reference to the following Description of the Example Embodiments and the accompanying drawings.

FIG. 1 shows a scheme depicting a pathway to scale multi-functional coaxial electrospun fibers into threads and woven into textiles.

FIG. 2 shows formation of aligned nano-/micro-fibers by coaxial electrospinning (left) and cross-sections of core/sheath fiber demonstrating control of interfacial chemistry and diameter (right).

FIG. 3 shows cross-sections of fiber structures demonstrating approach to control release rate and optimize lifetime.

FIG. 4 shows scanning electron micrographs of monofilament NP composites. Representative scale bars for top and bottom are 20 μm and 2 μm, respectively.

FIG. 5 shows fiber diameters of NP monofilament and coaxial fibers are shown in a box plot where dots represent individual measurements, and each box represents mean fiber diameter (center line) and standard deviation (top and bottom lines). One-way ANOVA and Tukey post-hoc analysis indicated NP10 was significantly different (p<0.05) from NP30, NP50, 15-5, 15-10, and 15-15, and there was a significant difference (p<0.05) between nylon-6,6 and 15-10.

FIG. 6 shows TGA profiles for NP composite fibers.

FIG. 7 shows isothermal a TGA profile for NP10.

FIG. 8 shows isothermal a TGA profile for NP30.

FIG. 9 shows isothermal a TGA profile for NP50.

FIG. 10 shows isothermal TGA profiles for all NP composites at 60° C.

FIG. 11 shows isothermal TGA profiles for all NP composites at 80° C.

FIG. 12 shows isothermal TGA profiles for all NP composites at 100° C.

FIG. 13 shows lifetimes extracted from isothermal TGA plots.

FIG. 14 shows an Arrhenius plot showing calculated activation energy (Eₐ) from respective linear regressions (dotted lines).

FIG. 15 shows ATR-IR spectra of neat picaridin, neat nylon, and NP composites showing full spectrum.

FIG. 16 shows ATR-IR spectra of neat picaridin, neat nylon, and NP composites showing region of interest.

FIG. 17 shows scanning electron micrographs of coaxial NP composites. NP composites were spun at constant sheath flow rates of 15 μL/min and variable core flow rates of 5, 10, and 15 μL/min. Representative scale bars for top and bottom are 20 μm and 2 μm, respectively.

FIG. 18 shows TGA ramp profiles for coaxial nanofiber composites.

FIG. 19 shows a TGA plot of heating ramps for monofilament and coaxial nylon-66 nanofibers.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

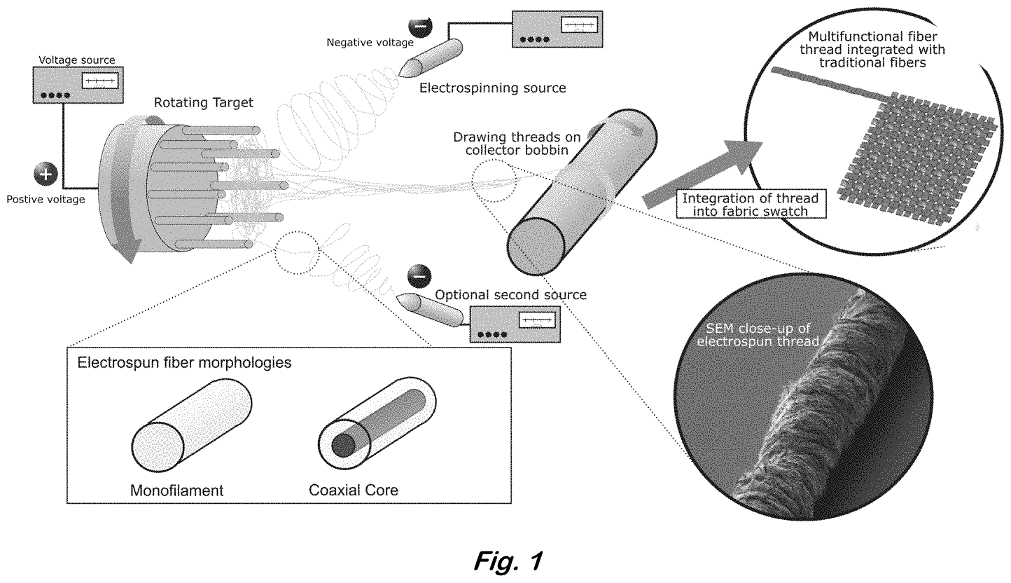

Disclosed herein are multifunctional fibers for the controlled delivery of environmentally friendly, low toxicity insect repellents encapsulated in the core of textile-relevant polymeric fibers, such as nylon, via coaxial electrospinning. The encapsulation of insect repellent (i.e. picaridin) into textile fibers via a bottom-up approach affords the potential to create fabrics and garments (FIG. 1) that exhibit similar feel of existing uniform fabrics, while also exhibiting superior performance. Incorporation of the active materials into the core of the fibers greatly enhance the durability of these functionalities to laundering, especially when compared with surface treatments, strongly reducing the current health hazards present for surface treated fibers and increasing their environmental sustainability.

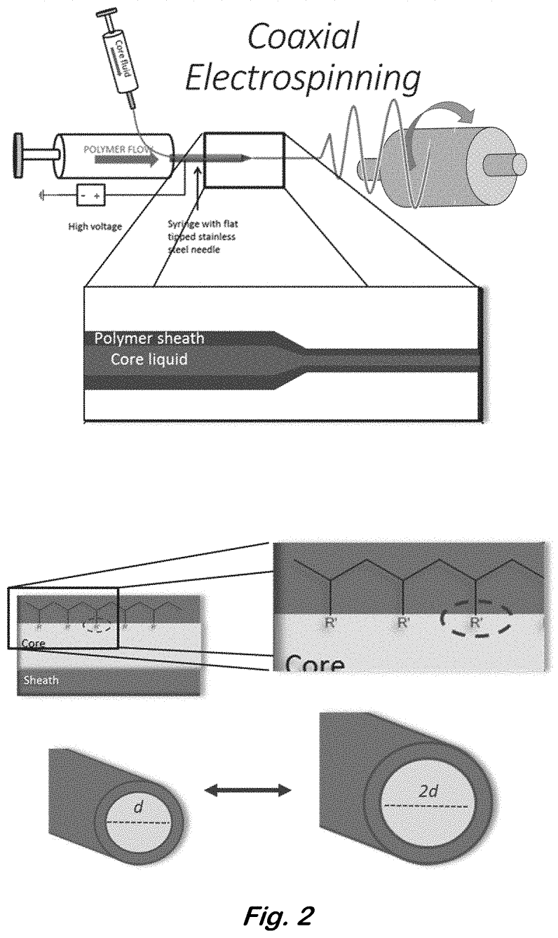

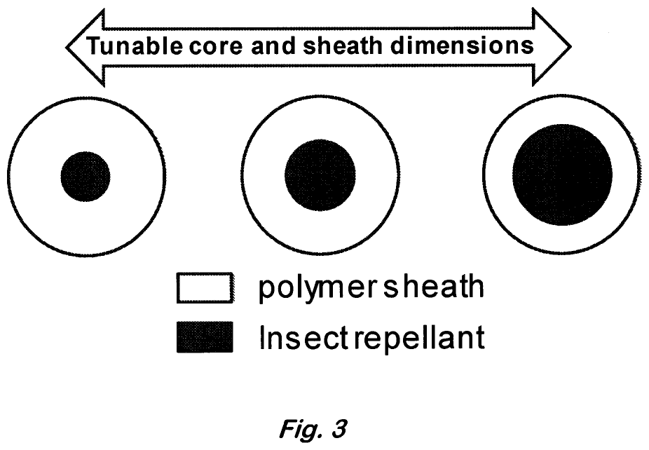

The fibers may contain environmentally friendly low toxicity insect repellents localized in textile-relevant polymeric fibers, such as nylon, with core-shell morphology via coaxial electrospinning. Specifically, coaxial fibers composed of nylon sheath and an insect repellent-loaded nylon core are presented. Coaxial electrospinning affords the potential to create hierarchically-structured functional micro- to nano-scale fibers by control over the composition of specific areas of the fiber (core vs. surface) (FIG. 2). By a controlled design of the polymer shell (i.e., thickness, composition, porosity, etc.) it is possible to tune the permeability of the polymer fiber to the additive in the core controlling its release (FIG. 3). This is significant for the insect repellent application, in which the release should be slowly occurring during the lifetime of the garments. Such functional fibers could then be further physically spun into threads and yarns for textile manufacturing. As each individual fiber can exhibit one or more distinct functionalities or contain different repellent compounds, various combinations could be spun into a single multifunctional yarn, or several monofunctional yarns could be woven into a multifunctional textile exhibiting broad-spectrum repellency.

The encapsulation of insect repellent (i.e. picaridin) into textile fibers via a bottom-up approach affords the potential to create fabrics and garments that exhibit similar feel of existing fabrics, while also exhibiting superior performance. Incorporation of the active materials into the core of the fibers will greatly enhance the durability of these functionalities to laundering, especially when compared with surface treatments, strongly reducing the current health hazards present for surface treated fibers and increasing their environmental sustainability. The insect repellent fibers have the potential to greatly reduce environmental and health risks during their lifecycle by 1) increasing the longevity of functionalities after laundering, 2) reducing direct skin contact of active additives by encapsulation within the core of a benign material, and 3) generating fibers from which textiles and garments could be designed with functionalities localized and limited only to the areas in which they are needed.

Compared to a monofilament construction, the sheath component of a coaxial fiber would aid in protecting additives in the core for more durable fabrics and act as a diffusion barrier for extended release applications. The sheath material offers the opportunity to tune diffusion rates based on composition, and afford additional control through the modulation of thickness. In this work, picaridin was incorporated into nylon-6,6 nanofibers via monofilament and coaxial electrospinning. The effects of fiber composition on fiber morphology and release kinetics on monofilament fibers were investigated. Coaxial fibers composed of picaridin loaded nylon core surrounded by an unloaded nylon sheath were fabricated and demonstrated altered release kinetics. This represents a facile method for generating defect-free, insect repellent fibers composed of a textile relevant polymer that can be tuned through traditional electrospinning methods or applied to conventional fiber fabrication methods.

The fiber contains a polymer and an insect repellant. Suitable polymers include, but are not limited to, textile fibers, nylon, nylon-6,6, rayon, spandex, polyester, and any other synthetic or natural polymers that may be made into a fiber by electrospinning. Suitable repellant include, but are not limited to, picaridin, DEET, and IR3535. The fiber may contain more than one polymer and/or repellant. The fiber may be a nanofiber having a diameter of less than 1 micron, less than 500 nm, or less than 300 nm.

The fiber may have a core-sheath structure, where the repellant is in the core. The sheath may optionally be made of the same polymer as the core. For example, both the core and sheath may be nylon with picaridin in the core. The structures of these compounds are shown below.

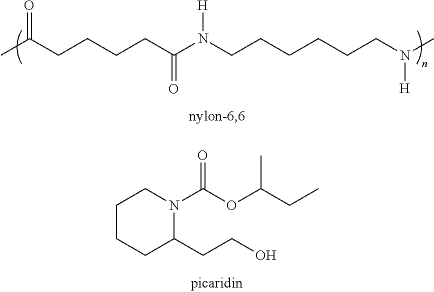

The fiber, including the core-sheath fiber, may be made by electrospinning, by techniques known in the art and as described herein. Both the core and the sheath may be made in the same electrospinning step.

The following examples are given to illustrate specific applications. These specific examples are not intended to limit the scope of the disclosure in this application.

Materials—Pelletized nylon-6,6 was purchased from Sigma-Aldrich (St. Louis, Mo.), while formic acid (88%) and picaridin (98%) were purchased from Fisher Scientific and Combi-Blocks, respectively, and used without further purification.

Electrospinning—All electrospun nanofibers were prepared from homogenous solutions with formic acid as solvent and a nylon-6,6 concentration of 12.5 wt %. In the case of nylon/picaridin (NP) composite fibers, a predetermined amount of picaridin was incorporated into the nylon-6,6 solutions to achieve nominal solution concentrations of 10, 30, and 50 wt % repellent with respect to nylon-6,6 solids content, designated as NP10, NP30, and NP50, respectively. All solutions were prepared using a FlackTek speedmixer at a spin rate of 3000 RPM until a clear, homogeneous solution was observed

Monofilament Electrospinning—Electrospinning was performed on a custom-built platform equipped with a syringe pump (New Era Pump Systems) containing a filled 12 mL syringe attached to a 22 G needle (D=0.020 in). Fibers were spun at 15 kV onto a grounded plate at a constant working distance of 10 cm and a flow rate of 15 μL/min.

Coaxial Electrospinning—The same procedure was used for coaxial spinning as for monofilament spinning, however, a coaxial needle (Rame Hart, Succasunna, N.J., inner needle i.d./o.d.=0.411/0.711 mm, outer needle i.d./o.d.=2.16/2.77 mm) was utilized where the outer needle solution was a pure (no repellent) nylon-6,6 solution (12.5% in formic acid) and the inner needle solution was a NP50 solution. To alter the fiber composition, the inner needle flow rate was systematically varied and set at 1, 5, 10, and 15 μL/min (15-1, 15-5, 15-10, 15-15, respectively), while the outer needle flow rate was held constant at 15 μL/min for all experiments. For both monofilament and coaxial experiments, electrospun nanofibers were allowed to dry at ambient conditions for 24 h to ensure any residual solvent was removed.

Scanning Electron Microscopy—Images of nanofiber morphology were obtained by scanning electron microscopy (SEM) on a JEOL JSM-7600F field emission SEM (Peabody, Mass.) at an operating voltage of 5 kV. Samples were sputter coated with least 3 nm of gold prior to SEM analysis using a Cressington 108 auto sputter coater equipped with a MTM20 thickness controller. Fiber diameters were measured from SEM images using ImageJ software (n>50). One-way ANOVA and Tukey post-hoc analysis were performed using Origin software.

Thermal Analysis—Analysis of fiber composition and release kinetics were characterized by thermogravimetric analysis (TGA) on a TA Instruments Discovery TGA using platinum pans. Heating ramps were performed at a heating rate of 10° C./min to 600° C. Isothermal measurements were performed in nitrogen atmosphere at 60, 80, and 100° C. for 5 h. Glass transition temperature (T_{g}) and thermal behavior were determined on a TA Instruments Discovery differential scanning calorimeter (DSC). Temperature ramps were performed from −50° C. to 300° C. at a rate of 10° C./min.

Fourier Transform Infrared Spectroscopy—Structural characterization of electrospun nanofibers was investigated through attenuated total reflectance Fourier transform infrared (ATR-FTIR) spectra using a Thermo Scientific Nicolet iS50-FT-IR spectrometer equipped with an iS50 ATR attachment and Ge crystal. Background and sample spectra consisted of 128 scans averaged together with 4 cm⁻¹ resolution at a scanner velocity of 10 kHz.

Results—Incorporation of the liquid repellent picaridin into solutions of nylon-6,6 in formic acid is expected to behave as a non-volatile diluent, due to the high boiling point (b.p.=296° C.), homogenously distributed throughout the fiber matrix during the electrospinning process, resulting in a composition-dependent fiber morphology. After confirmation that nylon/picaridin (NP) solutions were miscible over the composition range of interest, fiber morphology was analyzed.

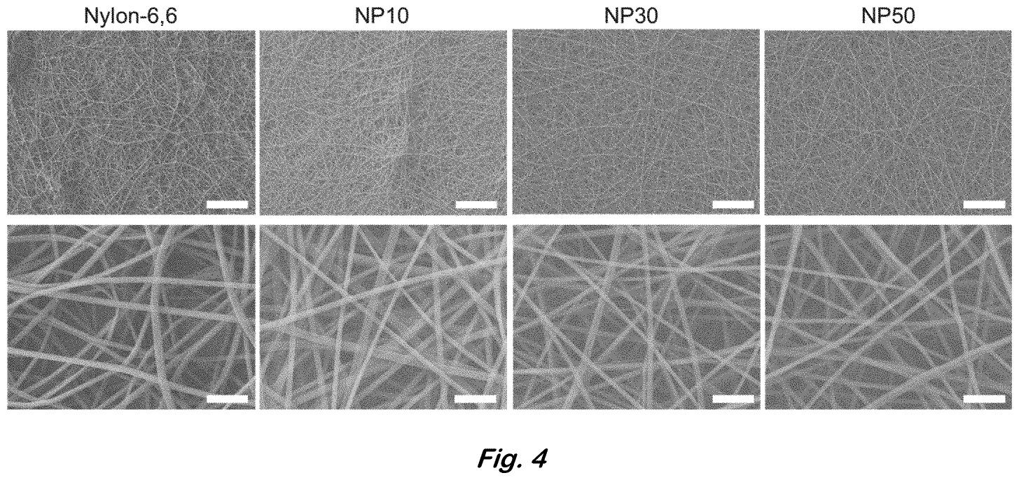

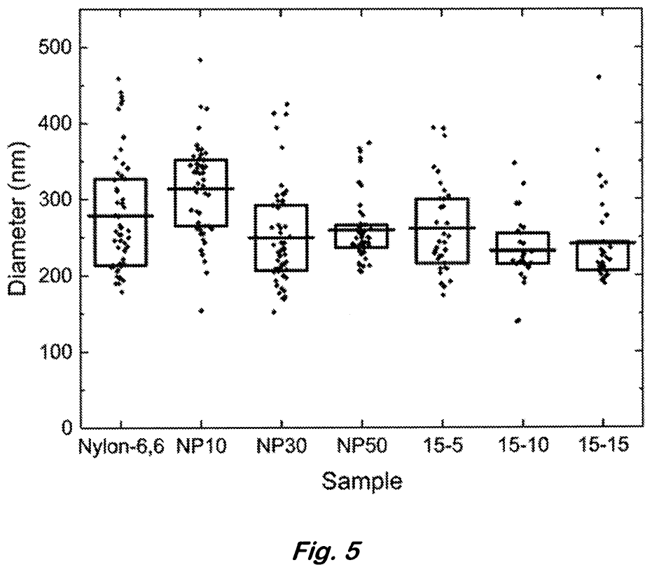

Monofilament Fiber Morphology and Composition—The effect of repellent content on fiber morphology was investigated with SEM. Representative scanning SEM images (FIG. 4) confirmed that all NP composite fibers were free of defects (e.g. globules, ill-defined shape, etc.) and able to be electrospun at all repellent compositions. Unloaded nylon fibers exhibited average fiber diameters of 279±76 nm. The morphology and size of nanofibers was largely unaffected by incorporation of picaridin even at extremely high (i.e. 50 wt %) loadings (FIG. 5). While fibers containing >50 wt % repellent have been fabricated previously, higher loadings can result in fibers with more defects due to unfavorable microstructure development and phase behavior (Bonadies et al., “Electrospun fibers of poly(l-lactic acid) containing DEET” AIP Conf. Proc. 2018, 1981(1), 020112; Bonadies et al., “Biodegradable electrospun PLLA fibers containing the mosquito-repellent DEET” Eur. Polym. J. 2019, 113, 377-384) unacceptable for development of durable fabrics and textiles, resulting in an investigation limited to the above compositions. This result was likely because the picaridin loading had minimal impact on the initial electrospinning polymer solution viscosity and dielectric properties, despite the significant weight contribution of picaridin to fibers after electrospinning. Importantly, picaridin loading did not have negative effects on morphology and size, thus potential development and use of such fibers for repellent textiles are not limited by picaridin loading levels.

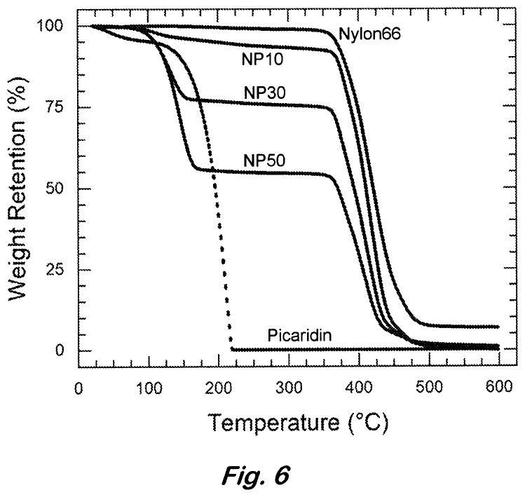

The overall composition of electrospun nanofibers were evaluated using thermogravimetric analysis (TGA). First, TGA ramps were performed to elucidate the overall repellent composition of each of the fibers. FIG. 6 shows TGA profiles for each of the NP composite fibers, where the weight loss of at temperatures less than 350° C. was attributed to loss of picaridin. A TGA ramp of pure picaridin is included for comparison. Without picaridin, nylon-6,6 did not exhibit weight loss below ˜350° C., indicating there was no residual formic acid in the monofilament fibers. Correspondingly, all NP composites also lost all formic acid during electrospinning, as each had only one weight loss step less than 350° C. from picaridin. In each case, the experimentally determined picaridin loading was slightly less than the nominal solution concentration used during spinning, indicating that most of the picaridin loading was maintained during the electrospinning process. Discrepancy in these two values can be explained by the low, but non-negligible vapor pressure of picaridin (˜3.3×10⁻² Pa) at ambient conditions, which resulted in a portion of the liquid repellent being lost to evaporation during the spinning process.

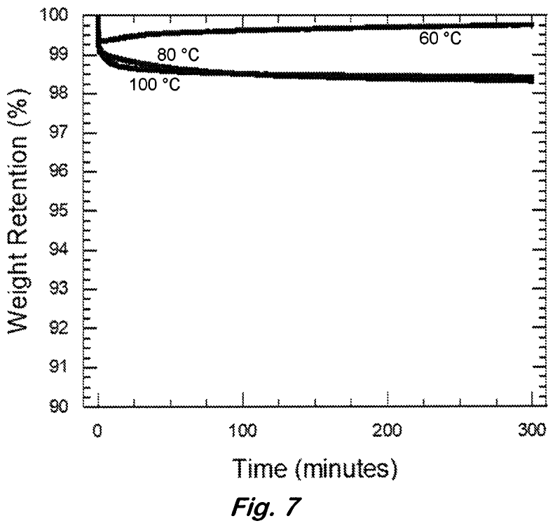

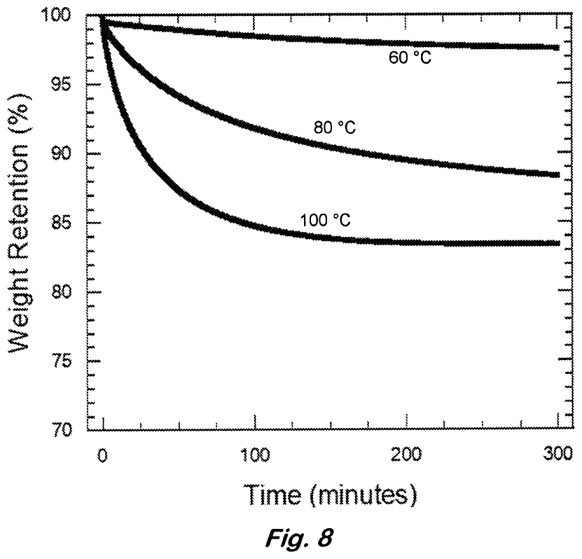

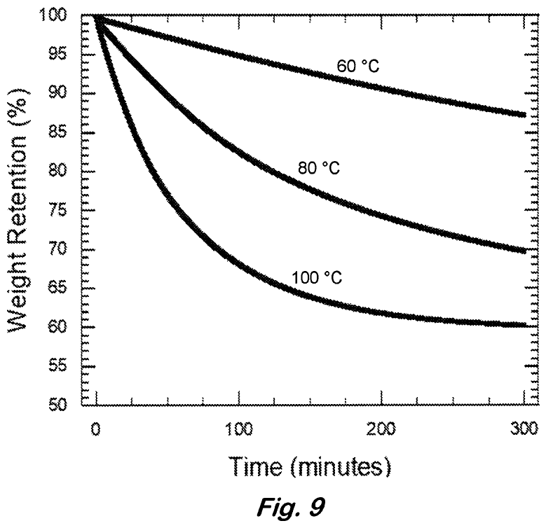

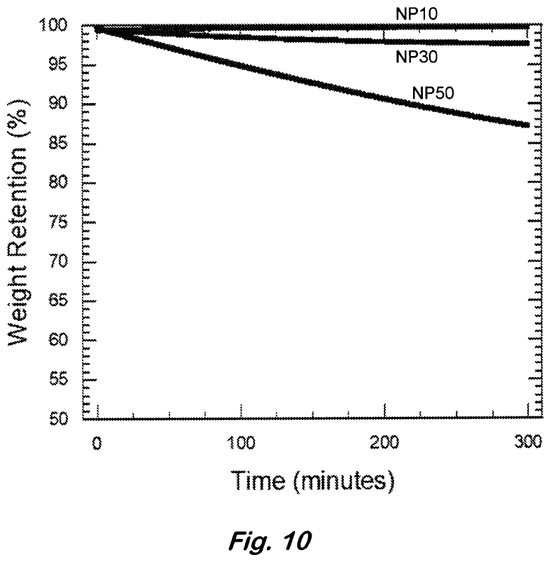

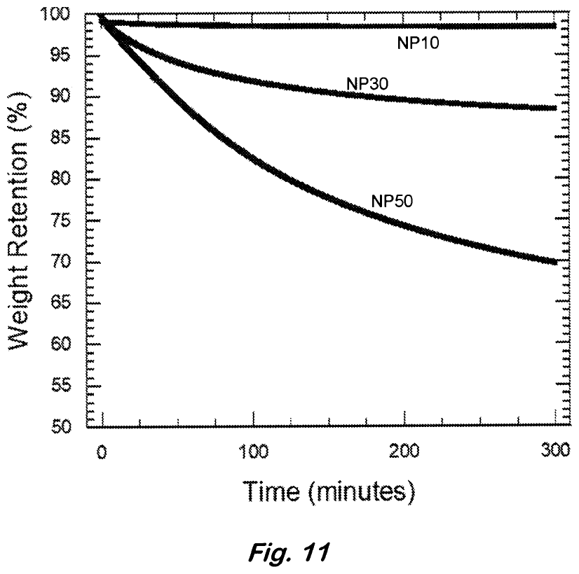

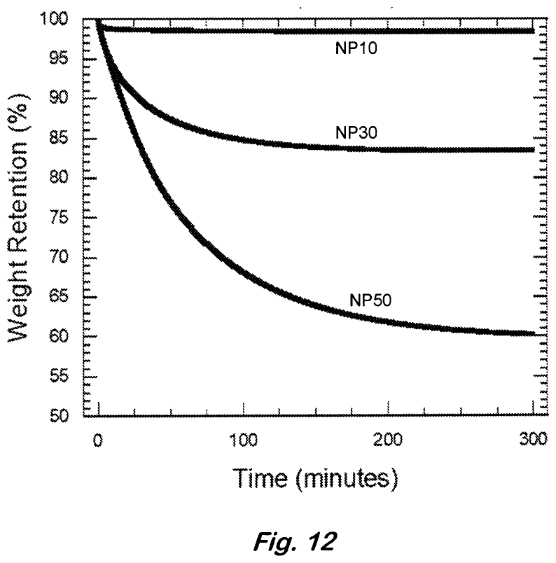

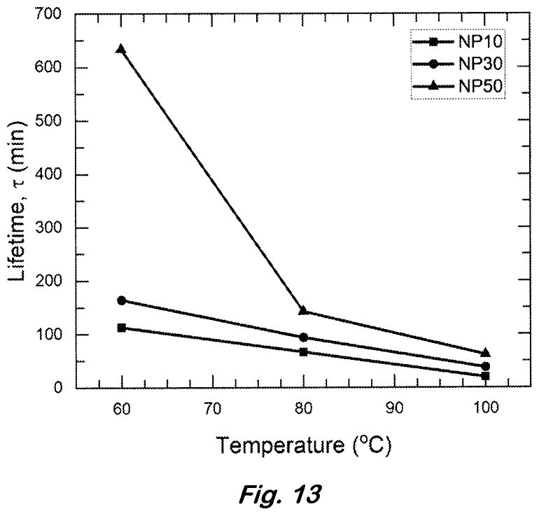

The effect of picaridin loading concentration on long-term release capability of electrospun NP fibers was evaluated by measuring picaridin release at several elevated temperatures, from which ambient performance can be extrapolated. Specifically, isothermal TGA experiments were performed for each of the fibers at 60, 80, and 100° C. to monitor the diffusion of picaridin from the fibers over time (FIGS. 7-12). Expectedly, the release rate of all samples increased with increasing temperature and increasing picaridin loading (FIGS. 7-9). Interestingly, none of the samples released all of the picaridin (noted by dashed horizontal lines) after 300 min at 100° C., demonstrating significant stability of the NP fibers as well as potential for long-term release capability at lower temperatures. Indeed, all samples continued to release picaridin at the maximum time measured, 300 min, even at 100° C. Comparison of NP composites at 60°, 80°, and 100° C. (FIGS. 10-12) demonstrated the effect of fiber composition at constant temperature on release behavior. In all cases, release profiles demonstrated exponential decay in weight retention, Wt, which corresponded to a first order loss of repellent with time that can be further modeled by a simple function of the form

$${W}_{t} = {W}_{0} ( exp \frac{- t}{τ} ) + 1$$

where t is the time in minutes, Wo is the initial weight, and τ is a time constant related to diffusion of picaridin through the electrospun nanofibers. FIG. 13 depicts the time constant, τ, as a function of temperature for each of the NP composites. In general, extrapolation of time constants across the temperature range demonstrates linear agreement for each sample, except for NP50 at low (60° C.) temperatures. This outlier was attributed to several underlying mechanisms that warrant further discussion. Since the fiber diameters for all fibers are statistically similar, there was no surface area effect difference between the samples. Therefore, differences in release profiles were likely due to differing concentration gradients resulting from increased picaridin loading.

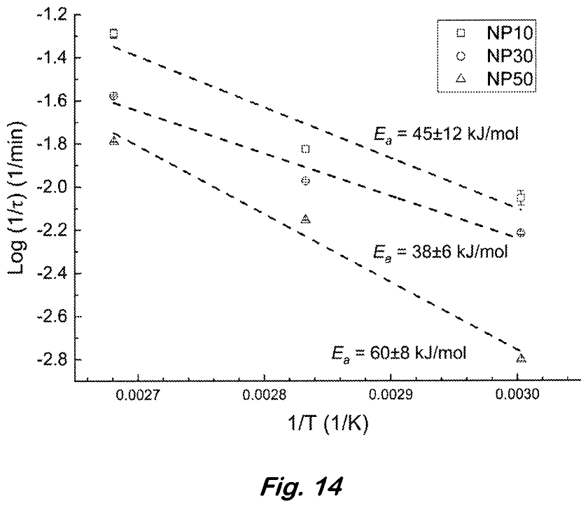

The inverse lifetime (1/τ) was fit to an Arrhenius plot (FIG. 14), from which the activation energy of insect repellent release for each NP composite was calculated from the relationship:

$$slope = \frac{- {E}_{a}}{2.3 R}$$

where Eₐ is the activation energy and R is the universal gas constant (8.314 J/K·mol). The activation energies for all NP composites fall within the range of 37-60 kJ/mol. NP10 and NP30 exhibited similar activation energies. NP50 demonstrated slightly higher activation energy at 60±8 kJ/mol, which was attributed to the effect of the 60° C. lifetime value on the slope of the NP50 plot. Using the calculated activation energy, the behavior of each composite at ambient temperature, 20° C., was extrapolated and resulted in half-lives (t_{1/2}) for release of 13.6, 13.0, and 132.7 h for NP10, NP30, and NP50, respectively.

In the case of each NP composite fiber, a simple assumption is made that the liquid repellent is homogenously dispersed/incorporated into the nylon matrix resulting in a uniform composition throughout. At relatively low loadings (i.e. NP10) it is presumed to be a good assumption. However, because picaridin and nylon-6,6 are not miscible, phase separation is expected to occur. At extremely high loadings of repellent (i.e. NP50), substantially more phase separation is expected to occur, due to physical confinement, resulting in a non-uniform dispersion of repellent within the polymer matrix. It is therefore anticipated that electrospinning results in a significantly higher repellent composition at the surface of the fiber compared to NP10 or NP30. Additionally, this repellent will inherently behave as a volatile, small-molecule diluent. Consequently, the repellent closest to the surface will diffuse out of the matrix very quickly leaving behind a glassy surface that becomes much more difficult for the picaridin to diffuse through at temperatures below the glass transition temperature of the matrix, resulting in very long repellent lifetimes.

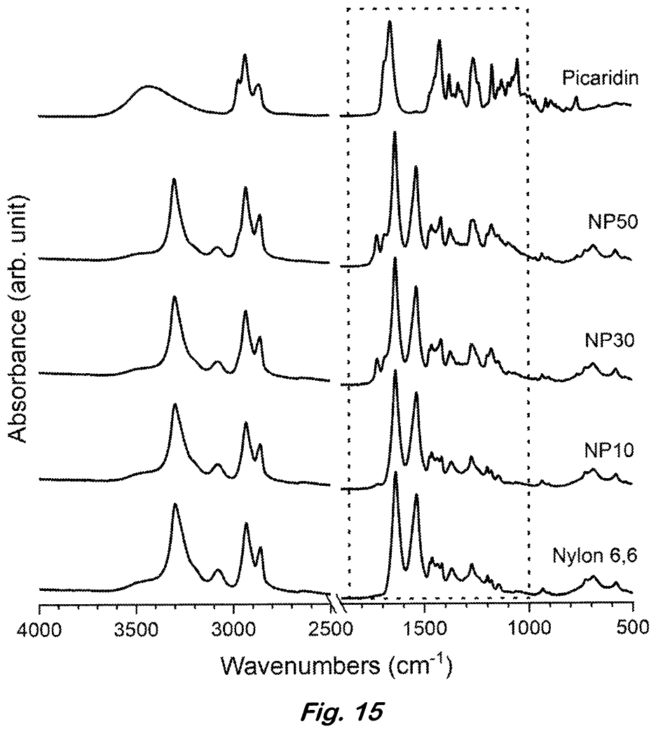

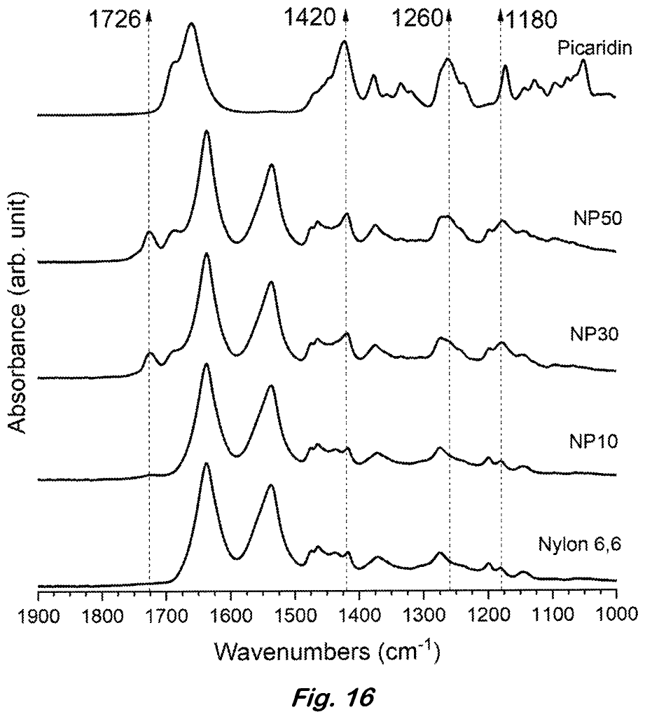

ATR-IR Analysis—The structural composition of the NP fibers were evaluated with ATR-IR. FIGS. 15 and 16 show overlay of NP composite spectra as compared to pure nylon-6,6 and picaridin. Neat picaridin exhibited characteristic broad absorbance at 3434 cm⁻¹ from νₛ(OH), sharp peaks at 2934 and 2866 cm⁻¹ corresponding asymmetric and symmetric CH₂ (νₐₛ(CH₂)), respectively, a shoulder at 1690 cm⁻¹ due carbamate carbonyl stretching (νₛ(C═O)), and a sharp peak at 1659 cm⁻¹ from hydrogen bonded carbamate carbonyl stretch (νₛ(C═O)). Neat nylon-6,6 demonstrated characteristic modes at 3300 cm⁻¹ (νₛ(NH)), 3078 cm⁻¹ (νₛ(HN—C═O)), 2932 and 2861 cm⁻¹ corresponding asymmetric (νₐₛ(CH₂)) and symmetric CH₂ (νₛ(CH₂)), respectively, 1636 cm⁻¹ from amide I carbonyl (νₛ(C═O)), 1536 cm⁻¹ from amide II band (νₛ(HN—C═O)), and 1275 cm⁻¹ attributed to the amide III band. Many of the strong absorbance bands of picaridin overlapped those of nylon-6,6 due to similarity in shared functional groups (amide/carbamate and alkyl moieties). In fact, the NP composites fibers exhibited very similar absorbance to neat nylon-6,6 across most of the IR region, even at the highest (NP50) loading levels. The NH (3300 cm⁻¹) and CH₂ (2800-3000 cm⁻¹) regions were largely unaffected by picaridin loading. Surprisingly, there was no shift in the nylon amide I carbonyl peak upon loading with picaridin, despite the carbamate carbonyl of picaridin absorbing at 1660 cm⁻¹ compared to the amide carbonyl of nylon-6,6 at 1636 cm⁻¹. Increased picaridin loading was confirmed by the increased intensity of several bands at 1690 cm⁻¹ (νₛ(C═O)), 1423 cm⁻¹ (δ(CH₂)), 1262 cm⁻¹ (νₛ(C—N)), and 1172 cm⁻¹ (νₛ(C—O)),), all of which did not shift relative to neat picaridin. Thus, not only did the increase in these peaks confirm picaridin loading in the nylon fibers, but their lack of shift from neat picaridin also indicated that there were minimal picaridin-nylon intermolecular interactions. Interestingly, the NP composites exhibited a new peak in the carbonyl region at 1726 cm⁻¹ that was attributed to small amounts of residual formic acid that remained due to stabilizing interactions with picaridin since the peak was not present in neat nylon nor picaridin (FIG. 16). Taken together, these results suggest that the majority of picaridin was physically entrapped within the nylon matrix. As such, release of picaridin from the monofilament nylon fibers would be expected to be dependent on diffusion of the picaridin insect repellent through the solid polymer matrix, relatively independent of intermolecular interactions.

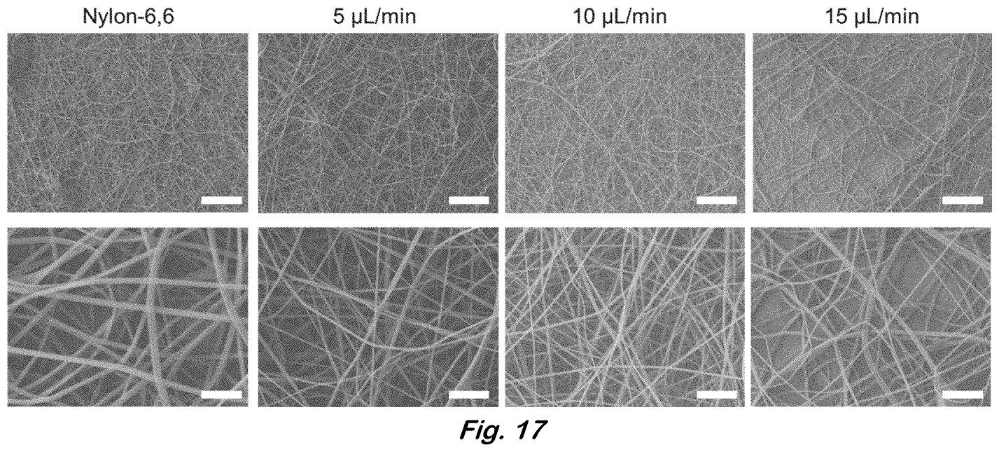

Coaxial Fiber Morphology and Composition—In an effort to impart an additional level of control over release kinetics and provide a protective barrier to water exposure, coaxial fibers composed of a picaridin loaded nylon core and an unloaded nylon sheath were fabricated via coaxial electrospinning, utilizing a method adapted from a previous study whereby the flow rates of the core and sheath solutions were manipulated to control fiber composition (Fong et al., “Beaded nanofibers formed during electrospinning” Polymer 1999, 40(16), 4585-4592). Specifically, the amount of picaridin loading in the core was controlled by modifying the core solution flow rate (5, 10, and 15 μL/min), which was a picaridin/nylon solution. SEM was used to visualize the effect of coaxial electrospinning and picaridin loading in the core on fiber morphology (FIG. 17). Fibers were formed in all cases, though a noticeable increase in defects (i.e. beads) was observed, especially at high core flow rates. This increase in defects is most likely due to the total mass flow exiting the needle tip to be greater than the optimal flow rate, that has been shown to produce beaded fibers from reduced charge density (Nerio et al., “Repellent activity of essential oils: A review” Bioresour. Technol. 2010, 101(1), 372-378). The fiber diameters of coaxial fibers were similar to those of the monofilament fibers in the range of 230-270 nm (FIG. 5). Furthermore, average coaxial fiber diameter was also unaffected by core flow rate. Therefore, all fiber samples exhibited comparable surface area to volume ratios such that differences in release rate were attributed to loading composition and morphology (monofilament vs. coaxial).

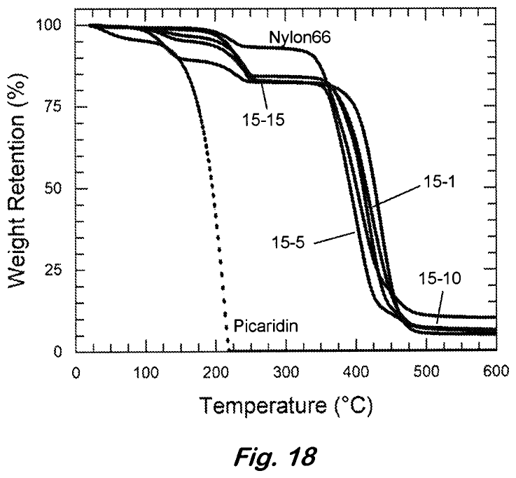

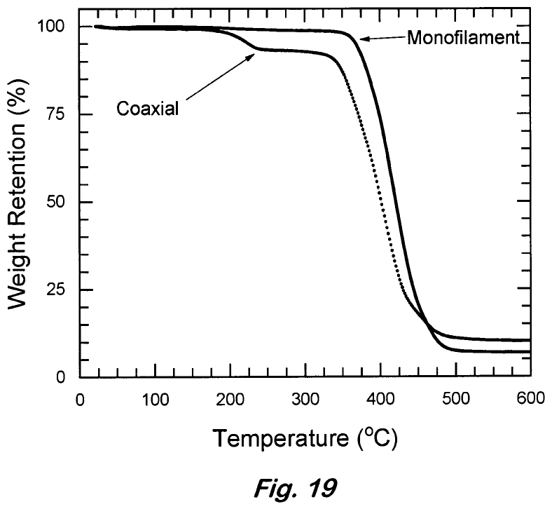

Repellent composition of the coaxial fibers was determined by TGA. FIG. 18 shows TGA heating ramps profiles for all coaxial samples. The first noticeable difference between the coaxial and monofilament profiles is the presence of two regions of mass loss, at −150 and −200° C. Additionally, in the case of the coaxial nylon-6,6 control, mass loss was also observed at −200° C. that was not observed in the case of the monofilament control (FIG. 19). As such, this mass loss was attributed to trapped residual solvent (formic acid) in the core of the hybrid coaxial nylon structure, suggesting that the mass loss at lower (−150° C.) temperature was due to incorporation of picaridin. This is surprising since the monofilament fibers, particularly neat nylon-6,6 fibers, did not exhibit this behavior. Therefore, coaxial electrospinning of nylon/nylon coaxial fibers imparted some barrier properties that reduced the amount of solvent from evaporating from the core of the fibers during electrospinning. While residual formic acid has potential for negative biocompatibility considerations, the results clearly demonstrated that facile coaxial design of nylon/nylon composites imparted significant barrier properties. Further analysis of the TGA profiles showed a systematic increase in picaridin composition with increasing core flow rate, demonstrating the ability to tune fiber composition in a simple manner. Indeed, the approximate nominal wt % loadings of the coaxial fibers were 3.5, 5.0, and 10.8 wt % for the 15-5, 15-10, and 15-15 coaxial fibers, respectively. Notably, the 15-15 coaxial fibers were comparable in loading concentration to the NP10 monofilament fibers as both were approximately 10 wt % picaridin.

Repellent nanofibers composed of picaridin in nylon-6,6 were successfully developed. A comparison of fiber morphology on release behavior was performed between monofilament and coaxial fibers. Monofilament composites with varying repellent concentrations were prepared and release rates were tuned and characterized via isothermal TGA. Expectedly, the release rate of all samples increased with increasing temperature and increasing picaridin loading. Importantly, fiber morphology and size was maintained with picaridin loading. Further, the monofilament NP fibers exhibited significant stability and potential for long-term release capability at ambient conditions since all composites continued to release picaridin even after 300 min at 100° C. Picaridin was physically entrapped in the nylon matrix, exhibiting minimal picaridin-nylon intermolecular interactions, thus indicating that differences in release profiles were likely due to differing concentration gradients dependent on diffusion through the solid polymer matrix.

Coaxial fibers were then developed and TGA demonstrated that the outer protective sheath altered the release of volatile components. Additionally, coaxial electrospun nylon/nylon coaxial fibers imparted barrier properties that reduced the amount of solvent from evaporating from the core of the fibers during electrospinning. Overall, this work demonstrates a facile method to fabricate nylon fibers with controlled release kinetics of insect repellent. Furthermore, the coaxial designs employed via electrospinning herein have the potential to be employed using conventional fiber drawing techniques.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A fiber comprising:
a polymer; and
picaridin.

2. The fiber of claim 1, wherein the polymer is a nylon.

3. The fiber of claim 1;
wherein the polymer and picaridin form a core of the fiber; and
wherein the fiber further comprises:
a polymer sheath surrounding the core.

4. The fiber of claim 3, wherein the polymer sheath comprises a nylon.

5. The fiber of claim 1, wherein the fiber has a diameter of less than 1 micron.

6. A fiber comprising:
a textile polymer; and
an insect repellant.

7. The fiber of claim 6, wherein the textile polymer is a nylon.

8. The fiber of claim 6;
wherein the textile polymer and insect repellant form a core of the fiber; and
wherein the fiber further comprises:
a polymer sheath surrounding the core.

9. The fiber of claim 8, wherein the polymer sheath comprises a nylon.

10. The fiber of claim 6, wherein the fiber has a diameter of less than 1 micron.

11. A fiber comprising:
a core;
wherein the core comprises a polymer and an insect repellant; and
a sheath;
wherein the sheath comprises the polymer.

12. The fiber of claim 11, wherein the insect repellant is picaridin.

13. The fiber of claim 11, wherein the fiber has a diameter of less than 1 micron.

14. A method comprising:
electrospinning a solution comprising a first polymer and an insect repellant to form a fiber.

15. The method of claim 14, wherein the first polymer is a textile polymer.

16. The method of claim 14, wherein the first polymer is a nylon.

17. The method of claim 14, wherein the insect repellant is picaridin.

18. The method of claim 14, further comprising:
electrospinning a second polymer simultaneously with electrospinning the solution to form a sheath of the second polymer surrounding a core of the first polymer and the insect repellant.

19. The method of claim 18, wherein the second polymer is the same as the first polymer.
